(19) United States
(12) Patent Application Publication
(10) Pub. No.: US 2009/0154570 A1
(43) Pub. Date: Jun. 18, 2009

(54) METHOD AND SYSTEM TO STREAM AND RENDER VIDEO DATA ON PROCESSING UNITS OF MOBILE DEVICES THAT HAVE LIMITED THREADING CAPABILITIES

(75) Inventor: Brainerd Sathianathan, San Jose, CA (US)

Correspondence Address: DLA PIPER LLP (US ), 2000 UNIVERSITY AVENUE, EAST PALO ALTO, CA, 94303-2248, US

(73) Assignee: AVOT MEDIA, INC., Sunnyvale, CA (US)

(21) Appl. No.: 12/273,892

(22) Filed: Nov. 19, 2008

Related U.S. Application Data
(60) Provisional application No. 60/989,001, filed on Nov. 19, 2007.

(51) Int. Cl. H04N 7/26; H04N 7/01

(52) U.S. Cl. 375/240.25; 375/E07.027; 348/441

(57) ABSTRACT

A system and method for playing videos on a processing unit of a mobile device with limited threading are provided that yield numerous benefits to a user of the mobile device.

### PRIORITY CLAIM

This application claims the benefit under 35 U.S.C. 119(e) and priority under 35 U.S.C. 120 to U.S. Provisional Patent Application Ser. No. 60/989,001 filed on Nov. 19, 2007 and entitled “Method to Stream and Render Video Data On Mobile Phone CPU's That Have Limited Threading Capabilities”, the entirety of which is incorporated herein by reference.

### FIELD

The field relates generally to video display on a mobile device and in particular the video delivery on mobile devices that have processing units with limited threading capabilities.

### BACKGROUND

There are 7.2 billion videos streamed in the Internet today from major video sharing sites. (See http://www.comscore.com/press/release.asp?press=1015.) In the month of December 2006 alone 58M unique visitors visited these sites. In the coming years this number is expected to triple.

The streaming of videos currently is very popular on desktop systems. However, it is not pervasive on mobile devices, such as mobile phones, due to the many constraints associated with the mobile device. One of the constraints is that most processing units on mobile devices have limited threading capability.

The thread scheduling on most embedded processing units, such as CPUs, are not very efficient, especially when one of the threads is decoding video data with high priority. As a result, the other low priority thread that is streaming the data from the network is “starved” or not given a chance to execute. This results in the video playback that is frequently being interrupted to buffer data from the network. Thus, it is desirable to provide a system and method to stream and render videos on mobile devices that have processing units with limited threading capability and it is to this end that the system and method are directed.

### BRIEF DESCRIPTION OF THE DRAWINGS

FIG. 1A illustrates an example of an implementation of a system for streaming and rending videos on a mobile device with limited threading capability;

FIG. 1B illustrates an example of a mobile device that operates with the system shown in FIG. 1A;

FIG. 2 illustrates an example of a method for streaming and rending videos on a mobile device with limited threading capability using shared window; and

FIG. 3 illustrates an example of a method for calculating red/green/blue (RGB) values from luma/chrominance (YUV) that is part of the method shown in FIG. 2.

### DETAILED DESCRIPTION OF ONE OR MORE EMBODIMENTS

The system and method are particularly applicable to a mobile phone with a limited threading capability processing unit for streaming and rendering video and it is in this context that the system and method will be described. It will be appreciated, however, that the system and method has greater utility since it can be used with any device that utilizes a limited threading capability processing unit and where it is desirable to be able to steam and render digital data.

The system and method provide a technique to efficiently stream and render video on mobile devices that have limited threading and processing unit capabilities. Each mobile device may be a cellular phone, a mobile device with wireless telephone capabilities, a smart phone (such as the RIM® Blackberry™ products or the Apple® iPhone™) and the like which have sufficient processing power, display capabilities, connectivity (either wireless or wired) and the capability to display/play a streaming video. However, each mobile device has a processing unit, such as a central processing unit, that has limited threading capabilities. The system and method allows user of the each mobile device to watch streaming videos on the mobile devices efficiently while conserving battery power of the mobile device and processing unit usage as described below in more detail.

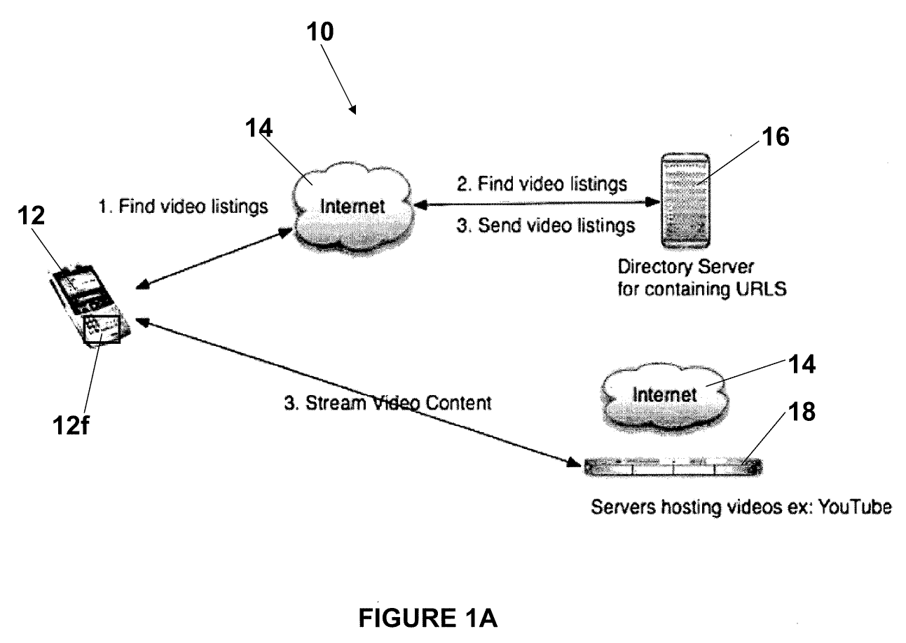

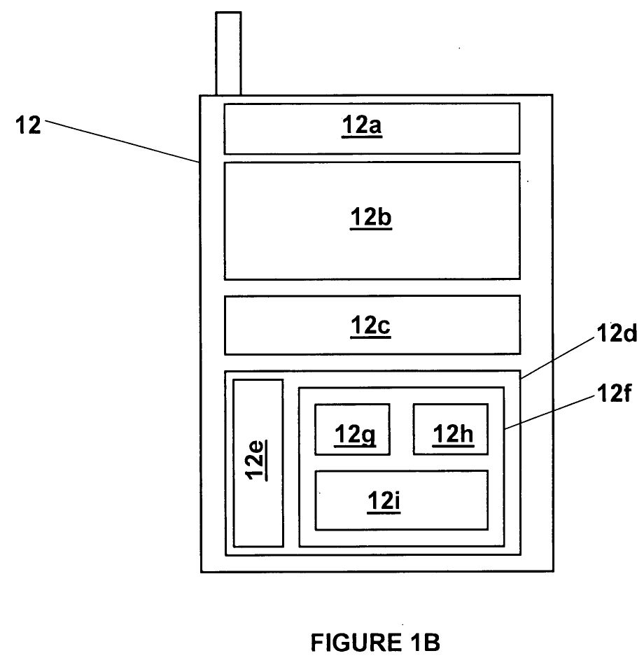

FIG. 1A illustrates an example of an implementation of a system 10 for streaming and rending videos on a mobile device with limited threading capability. The system may include one or more mobile devices 12 as described above wherein each mobile device has the processing unit (not shown) and a video module 12f that manages and is capable of streaming content directly from one or more content units 18 over a link 14. In one embodiment, the video module may be implemented as a plurality of lines of computer code being executed by the processing unit of the mobile device. The link may be any computer or communications network (whether wireless or wired) that allows each mobile device to interact with other sites, such as the one or more content units 18. In one embodiment, the link may be the Internet. The one or more content units 18 may each be implemented, in one embodiment, as a server computer that stores content and then serves/streams the content when requested. The system 10 may further comprises one or more directory units 16 that may be implemented as one or more server computers with one or more processing units, memory, etc. The one or more directory units 16 are responsible for maintaining catalog information about the various content streams and their time codes including uniform resource locators (URLs) for each content stream, such as video stream, that identifies the location of each content stream on the one or more content sites 18 which may be implemented, in one embodiment, as one or more server computers that are coupled to the link 14. The one or more directory units 16 may also have a search engine that crawls through available web content and collects catalog information as is well known and this engine is useful for user generated content as the information for the premium content data is derived directly from the content provider.

In the system, a user of a mobile device can connect to the one or more directory units 16 and locate a content listing which are then communicated from the one or more directory units 16 back to the mobile device 12. The mobile device can then request the content from the content units 18 and the content is streamed to the video unit 12f that is part of the mobile device.

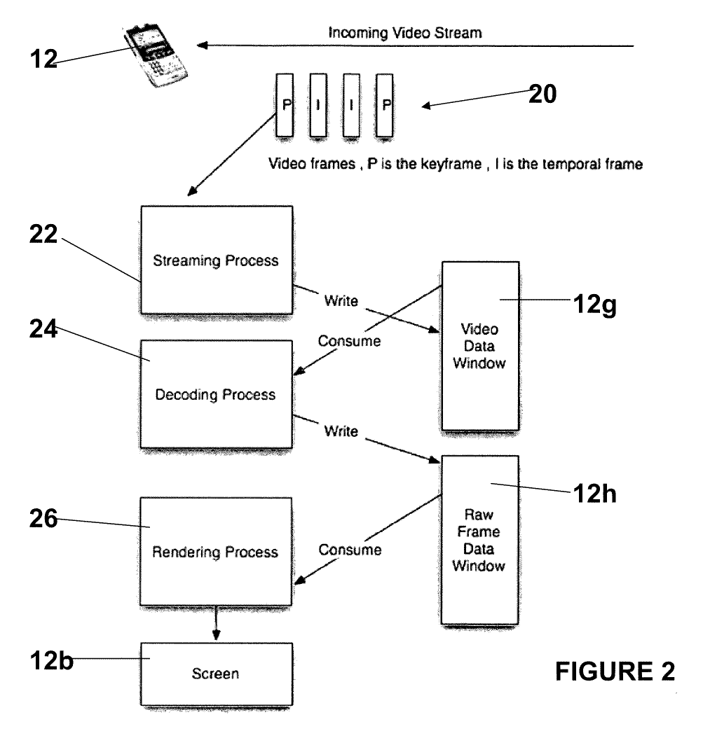

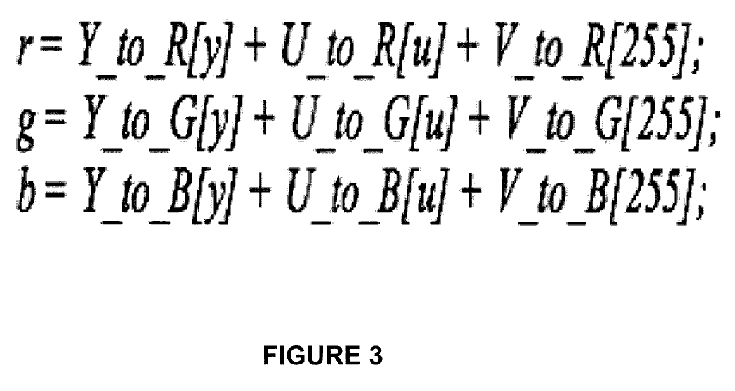

FIG. 1B illustrates more details of each mobile device 12 that is part of the system shown in FIG. 1A. Each mobile device may comprise a communications unit/circuitry 12a that allows the mobile device to wirelessly communicate with the link as shown in FIG. 1A, such as by wireless RF, a display 12b that is capable of displaying information and data associated with the mobile device 12 such as videos and one or more processing units 12c that control the operation of the mobile device by executing computer code and instructions. Each mobile device 12 may further comprise a memory 12d that temporarily and/or permanently stores data and instructions that are executed or processed by the one or more processing units. The memory 12d may further store an operation system 12e of the mobile device and a video unit 12f wherein each of these comprise, in one implementation, a plurality of lines of computer code that are executed by the one or more processing units 12c of the mobile device. The video unit 12f may further comprise a first portion of memory 12g and a second portion of memory 12h used for buffering data as described below with reference to FIG. 2 and a conversion unit 12i that contains conversion tables and the process to covert pixels from one format to another format as described below with reference to FIG. 3.

In operation, the video unit 12f executing on the mobile device 12 streams content, such as videos, from the link and the video unit spawns child applications and each child application will be involved in a specific task such as streaming video, decoding video, decoding audio, rending video to screen. All such process will share a file mapped memory region or a “memory window” through which video and audio data is transmitted to each other. There are two different types of mobile phone devices that are in use today: smart phones and feature phones. Smart phones are devices tat have a higher CPU processing capabilities namely with 200-500 MHz CPU with optimizations to perform multimedia operations. Most multimedia functionality is supported and accelerated thorough the help special purpose integrated circuits. Smart phones also have a general purpose operating system for which applications can be built etc. On the other hand featured phones have limited CPU's specialized for executing voice related functions. Streaming or rendering video o such devices is not possible. Some newer featured phone models do have support for multimedia in a limited manner. If one has to undertake an application to render and stream video and sound on such devices it becomes an impossible task unless careful consideration is given to the implementation. There are few techniques we employed to make this possible on smaller devices without the aid of specialized accelerating hardware components.

FIG. 2 illustrates an example of a method for streaming and rending videos on a mobile device with limited threading capability using shared window. As shown, an incoming content stream 20, such as a video stream, to the mobile device 12 may have one or more frames that make up the video stream such as one or more P frames 20a which are keyframes and one or more I frames 20b which are temporal frames. The video unit 12f of the mobile device may execute three processes to stream, decode and playback video. The processes, in the example of video content, may include a streaming process 22, a decoding process 24 and a rendering process 26. In one embodiment, these processes 22-26 may each be implemented as a plurality of lines of computer code within the video unit 12f that are executed by the processing unit(s) of the mobile device. The streaming process receives content data from the link and streams it into a window 12g as described above. The decoding process decodes the content data, which is compressed/encoded and generates raw frame data for the video and the rendering process renders the video (from the raw frame data output by the decoding process) for display on a screen 12b of the mobile device.

The streaming process 22 and the decoding process 24 share a file mapped memory window (video data window 12g such as a portion of memory in the mobile device in one embodiment) though which data is shared wherein the streaming process writes to the window 12b while the decoding process consumes from the window 12g. When the streaming process (which writes the streaming content data into the window) reaches the bottom of the window, it circulates back to the top (like a circular buffer) and start writing at the top of the window provided that the content at the top of the window has already been consumed by the decoding process 24. If the window 12g is full or the decoding process 24 did not consume the data in the portion of the window that the streaming process 22 is trying to write new content data into, then the writing or the streaming process will pause. In most video player implementations, memory blocks are transferred from one subsystem to the other and thus this transfer will hold up resources including the processing unit because the default shared memory offered by the mobile device system is not efficient on mobile devices without using the above-mentioned windowing scheme. In systems that support hardware acceleration, both the video decoder and the audio decoder will leverage such acceleration.

The decoding process 24 and the rendering process 26 may share another file mapped memory window (raw frame data window 12h such as a portion of memory in the mobile device in one embodiment.) As decoding happens, the decoding process 24 will write raw frame content data to this window 12h and the rendering process 26 consumes the raw frame data from this window 12h. The decoding process 24 may wait if it has not got enough video data to decode. The rendering process 26 may also wait until it has received at least a single frame to render. In case the video is paused by the user, content of this shared window 30 is transferred into a memory cache of the mobile device. Then, when the content is played again, the content is moved from the cache onto the screen 12b for rendering. Since processes instead of threads are used in the system and method, the operating system of the mobile device will give equal priority and will not “starve” any single operation.

The system may also incorporate YUV color conversion. Video data in most codec implementations is handled by converting the video data into the known YUV color scheme because the YUV color scheme efficiently represents color and enables the removal of non significant components that are not perceived by the human eye. However this conversion process is very processing unit intensive, consist of several small mathematical operations and these operations in turn consume more processing unit cycles and computational power, which are scarce resource on mobile phones. The system uses an efficient methodology of providing file mapped lookup tables to perform this computation and completely avoiding standard mathematically operations, resulting in efficient processing unit usage.

FIG. 3 illustrates an example of a method for calculating red/green/blue (RGB) values from luma/chrominance (YUV) that is part of the method shown in FIG. 2. In the system, which is implemented in the video unit 12f as a conversion unit that is a plurality of lines of computer code that can be executed by the processing unit of the mobile device, the conversion unit makes use of look up tables stored in memory of the mobile device to replace repetitive computations. When a conversion method, implemented by the conversion unit, is first called, a static look up tables is generated. The tables make use of 256 (values)×9 (number of tables)×2 (each row) memory bytes, which is approximately 4608 bytes.

In one embodiment, the tables are implemented as follows:

Y_to_R[255], Y_to_G[255], Y_to_B[255], U_to_R[255], U_to_G[255], U_to_B[255],

V_to_R[255],V_to_G[255], and V_to_B[255].

The tables thus contains a conversion table for each YUV element to each RGB element so that a simple summation is therefore sufficient for calculation instead of multiplications. For instance, if the Y,U,V values of a pixel are y, u, v, then the corresponding r,g,b values for the pixel are calculated using the equations shown on FIG. 3 which require simple addition of the values contained in the tables. The values of the table remain static and calculated one time based on the domain translation logic.

While the foregoing has been with reference to a particular embodiment of the invention, it will be appreciated by those skilled in the art that changes in this embodiment may be made without departing from the principles and spirit of the invention, the scope of which is defined by the appended claims.

1. A mobile device, comprising:
a processing unit;
a display;
a memory associated with the processing unit;
a video unit that has a steaming process, a decoding process and a rendering process;
a first window in the memory for storing encoded content data;
a second window in the memory for storing raw content data; and
wherein the streaming process receives encoded content data from a link and stores it into the first window and the decoding process decodes the encoded content data in the first window and stores the raw content data in the second window and the rendering process retrieves the raw content data from the second window and renders the content that is displayed on the display.

2. The device of claim 1, wherein the first window and the second window are each buffers located in different portions of the memory.

3. The device of claim 1, wherein the video unit further comprises a conversion unit having a plurality of look-up tables wherein a conversion from a first format signal to a second format signal is done by adding values read from the look-up tables.

4. The device of claim 3, wherein the first format signal further comprises YUV signal and the second format signal further comprises RGB signal.

5. The device of claim 4, wherein the plurality of look-up tables further comprises a Y to R table that converts a Y value to a R value, a Y to B table that converts a Y value to a B value, a Y to G table that converts a Y value to a G value, a U to R table that converts a U value to a R value, a U to B table that converts a U value to a B value, a U to G table that converts a U value to a G value, a V to R table that converts a V value to a R value, a V to B table that converts a V value to a B value and a V to G table that converts a V value to a G value.

6. The device of claim 5, wherein the conversion unit computes a red value based on the addition of a value in the Y to R table corresponding to the Y value of the YUV signal, a value in the U to R table corresponding to the U value of the YUV signal and a value in the V to R table corresponding to the V value of the YUV signal.

7. The device of claim 5, wherein the conversion unit computes a blue value based on the addition of a value in the Y to B table corresponding to the Y value of the YUV signal, a value in the U to B table corresponding to the U value of the YUV signal and a value in the V to B table corresponding to the V value of the YUV signal.

8. The device of claim 5, wherein the conversion unit computes a green value based on the addition of a value in the Y to G table corresponding to the Y value of the YUV signal, a value in the U to G table corresponding to the U value of the YUV signal and a value in the V to G table corresponding to the V value of the YUV signal.

9. A method to stream and render content data on a mobile device having a processing unit; a display; a memory associated with the processing unit and a video unit that has a steaming process, a decoding process and a rendering process, the method comprising:
providing a first window in the memory for storing encoded content data;
providing a second window in the memory for storing raw content data;
receiving, using the streaming process, encoded content data from a link and storing the encoded content data into the first window;
decoding, using the decoding process, the encoded content data in the first window and storing the raw content data in the second window;
retrieving, using the rendering process, the raw content data from the second window; and
rendering, using the rendering process, the content that is displayed on the display.

10. The method of claim 9 further comprising converting content data from a first format signal to a second format signal using look-up tables.

11. The method of claim 10, wherein the first format signal further comprises YUV signal and the second format signal further comprises RGB signal.

12. The method of claim 11, wherein converting content data further comprises determining a red value based on the addition of a value in a Y to R table corresponding to the Y value of the YUV signal, a value in a U to R table corresponding to the U value of the YUV signal and a value in a V to R table corresponding to the V value of the YUV signal.

13. The method of claim 11, wherein converting content data further comprises determining a blue value based on the addition of a value in a Y to B table corresponding to the Y value of the YUV signal, a value in a U to B table corresponding to the U value of the YUV signal and a value in a V to B table corresponding to the V value of the YUV signal.

14. The method of claim 11, wherein converting content data further comprises determining a green value based on the addition of a value in a Y to G table corresponding to the Y value of the YUV signal, a value in a U to G table corresponding to the U value of the YUV signal and a value in a V to G table corresponding to the V value of the YUV signal.
